(19) United States
(12) Patent Application Publication
(10) Pub. No.: US 2016/0019426 A1
(43) Pub. Date: Jan. 21, 2016

(54) METHOD OF VIDEO ANALYSIS

(71) Applicant: Apical Ltd., London (GB)

(72) Inventors: Michael TUSCH, London (GB); Ilya ROMANENKO, London (GB); Alexey LOPICH, London (GB)

(21) Appl. No.: 14/801,041

(22) Filed: Jul. 16, 2015

(30) Foreign Application Priority Data
Jul. 18, 2014 (GB) 1412846.6

(51) Int. Cl. G06K 9/00; G11B 27/034; G06K 9/32; G11B 27/031; G11B 27/34

(52) U.S. Cl. CPC G06K 9/00765; G11B 27/031; G11B 27/34; G06K 9/3241; G11B 27/034

(57) ABSTRACT

A method for analyzing a video stream is provided. The method determines a set of two or more frames containing an object, and generates an object record describing time evolution of at least one characteristic of the object. An apparatus comprising a processor and a memory to perform this method is also provided.

### CROSS-REFERENCE TO RELATED APPLICATIONS

This application claims priority under 35 U.S.C. §119 to GB Patent Application No. 1412846.6, filed Jul. 18, 2014, the entire contents of which is hereby incorporated herein by reference in its entirety.

### BACKGROUND OF THE INVENTION

1. Field of the Invention

The present invention relates to a method of analyzing a video stream and generating metadata, which may be transmitted to a different location.

2. Description of the Related Technology

It is desirable to analyze recorded or live-streamed video and to produce compact metadata containing the results of the analysis. If the metadata are to be analyzed at a remote location, simply streaming this metadata may be inconvenient, as the amount of data may become large over time. A method is required that reduces the amount of metadata.

In addition, it may be desirable to perform analysis at a remote device which generates results comparable to those that could be derived by analysis of the original video. According to prior art techniques, this would require the video stream to be transmitted to the server in full. Transmission of the video in full is inefficient, and a method is required for more efficient transmission

### SUMMARY

According to a first aspect of the present invention, there is provided a method for analyzing a video stream having frames, the method comprising:
determining a set of the frames in which an object is present using an object detection algorithm; and
generating at least one object record from content of the video stream, the object record including time evolution of at least one characteristic of the object in the set of the frames.

This solves the problem of reducing the amount of metadata as only selected metadata is included in the object record. This is convenient for storage, transmission and indexing.

The method preferably includes analyzing the object record, which may be performed at the same location as the determining a set of frames and the generating at least one object record, or at a different location.

The invention further relates to a first apparatus for processing a video stream having frames at a first location, the apparatus comprising
at least one processor; and
at least one memory including computer program instructions,
wherein the at least one memory and the computer program instructions being configured to, with the at least one processor, cause the apparatus to perform the method of:
determining a set of the frames in which an object is present using an object detection algorithm;
generating at least one object record from content of the video stream, the object record including time evolution of at least one characteristic of the object in the set of the frames.

The invention further relates to a second apparatus for processing an object record, including time evolution of at least one characteristic of an object at a second location, the apparatus comprising:
at least one processor; and
at least one memory including computer program instructions,
wherein the at least one memory and the computer program instructions being configured to, with the at least one processor, cause the apparatus to perform the method of:
receiving the object record from a first location;
analyzing the object record; and
obtaining a result of the analyzing.

The invention further relates to system for processing a video stream, including a first apparatus and a second apparatus as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a method for generating metadata and analysis of that metadata.

FIG. 2 shows a method for generating metadata from a video frame.

FIG. 3 shows various key points over the lifetime of an object identified in a video stream.

FIG. 4 shows the combination of two object records to form a combined object record, in response to determining that the detected objects correspond to the same object.

FIG. 5 shows two systems implementing the method of FIG. 1.

### DETAILED DESCRIPTION OF CERTAIN INVENTIVE EMBODIMENTS

Video analysis techniques may be applied to pre-recorded video stored in memory, and also to real-time video, for example shot by a camera. The video may be the result of image processing within a camera module or may consist of the raw data stream, e.g. output by a CMOS or CCD sensor. This video may be analyzed to produce data relating to the content of the video stream, such as metadata; for example, an object detection algorithm may be applied to identify objects present in the video stream.

Multiple objects may be detected in the video stream, either at the same point in the video stream or at different points, and if so, the method described herein may be applied to each detected object. In this case, the data may comprise a set of characteristics of the object or objects in the video stream. Examples of such characteristics include an identifier for each object, the location and size of each object within the frame of the video, the object type (for example “person” or “dog”), parts of the object (for example, “head”, “upper body”) and their angles of orientation, a detection score describing the accuracy of the detection, and an indication of the most probable orientation angle for each object (for example, distinguishing a human face oriented towards the camera from one oriented to the side). Other descriptive data may be included in the data, such as a histogram or other metric of object color such as an average value and standard deviation for each color component, or a thumbnail corresponding to a cropped portion of the image.

Some of these characteristics may vary over the period of time in which a specific object is present, and the data may reflect this by, for example, storing a separate value for each video frame of the set of frames in which the object is present or for a subset of frames of said set of frames. A collection of data showing the time evolution of one or more of such characteristics for a given object over a series of frames in which the object is present may be referred to as a “track record” or an “object record”. An object record may for example be encoded in an ASCII XML format for ease of interpretation by third-party tools.

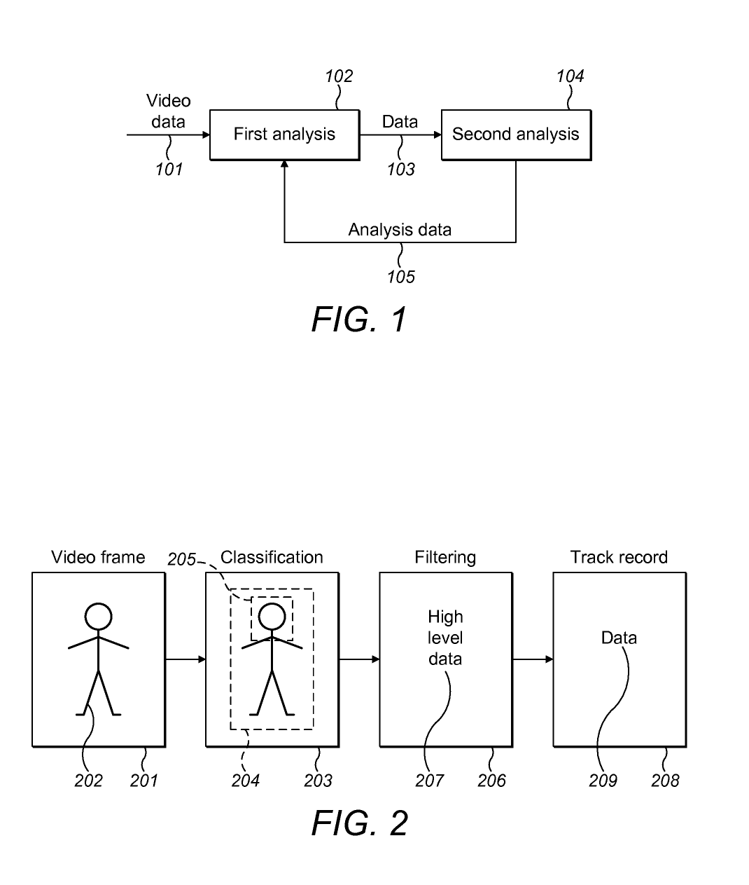

FIG. 1 shows schematically a method according to one embodiment, in which an object record may be generated and analyzed. A source, for example a camera producing live footage or a memory in which a video file is stored, provides video data 101, such as a video stream, on which a first analysis 102 using an object detection algorithm is performed in a first processing system. This analysis identifies the frames or a set of frames in which an object is present. An object record is then produced which includes data 103 such as metadata as described above, which may be transmitted for a second analysis 104 in a second processing system. The one or more object records are preferably not streamed continuously but may instead be transmitted in at least one chunk or part at a time.

The first and second processing systems may be contained within the same device, such as a smartphone or a camera, or they may be remotely located. For example, the first processing system may be within a camera at a first location and the second processing system may be within a remote server at a second location. As another example, the first processing system may be a computer which retrieves a video file from memory. The second processing system analyses the one or more object records, and according to some embodiments may transmit data 105 containing at least one result of this analysis back to the first processing system. The result of the analysis may be stored in a video file containing at least part of the analyzed video.

According to some embodiments the first processing system is a camera and the second processing system is a computer system, for example a server. Alternatively, both analysis steps may be performed in the same processing system. Analysis of video in such a camera, to produce an object record, is shown in more detail in FIG. 2. A video stream may contain frames, each of which includes an image. FIG. 2 depicts a video frame 201 containing an object 202, in this case a human figure. The frame is analyzed in an object detection step 203.

Object detection algorithms are well known in the art and include, for example, facial detection algorithms which have been configured to detect human faces at a given angle of orientation. Facial detection algorithms may be based on the method of Viola and Jones. Other examples capable of detecting human body shapes in whole or in part as well as other types of objects with characteristic shapes are known, and may be based on a histogram of oriented gradients with a classifier such as a support vector machine or, for example, using a convolutional neural network. In this example, object detection algorithms are utilized to determine that the image contains a human FIG. 204, the circumference being indicated by a dashed line in the figure, and, within this, a human face 205, shown by a dashed circumference. These individual instances of identification of specific objects may be termed “detections”.

Multiple detections may correspond to a single object. For example, in FIG. 2, the detected human figure and the detected human face correspond to the same person in the frame. Further, a detection algorithm may detect a single object, such as a face, at multiple different size scales and spatial offsets clustered around the actual object. The process of identifying single objects captured by multiple detections may be termed “filtering”. The detections may be filtered in a filtering step 206, which may for example group multiple detections within a close spatial and temporal range of each other as a single object. A temporal range may be expressed as a range of frames in the video stream. The filtering step may also include searching for predetermined combinations of detections, such as a human face and a human body, and grouping these. In this example, the filtering step may determine that the human figure and human face overlap sufficiently to conclude that they correspond to the same object (the human 202); data about such a combination of detections from multiple classifiers into single objects may be termed “high level data” 207.

A detected object may be analyzed to generate an object record 208 from content of the video stream, the object record comprising data 209, which may describe a wide variety of characteristics of the object, including but not limited to:
a unique identifier corresponding to the object;
an indicator of the frame or time at which the object first appears in the video stream (the first frame in which the object is present);
an indicator of the frame or time at which the object disappears from the video stream (the last frame in which the object is present);
location of the object within the frame, for example expressed as the offset of a box bounding the object from a corner of the frame, e.g. the top left corner;
size of the object, for example expressed as the height and width of a box bounding the object;
object type; possible types include “person”, “car”, “dog”, etc.;
the most likely orientation of the object and/or an indicator of the frame or time at which the object has a given orientation;
detection score, describing the accuracy of detection of the object, or the degree of confidence in its identification;
track confidence, indicating the probability that information in the object record is accurate;
“tracking life”, typically a value which decreases for each frame in which a previously detected object is undetected and increases for each frame in which an object is visible;
velocity of the object, determined over a number of frames;
one or more metrics describing the distribution of colors within the object;
a timestamp, indicating the time at which the frame was captured; or
any other relevant descriptive information regarding the object.

The data is recorded for a set of frames in which the object is detected, the set of frames comprising at least two frames. The object record comprises a record of the time evolution of at least one characteristic of an object over the set of frames in which the object is present in the video stream. The set of frames, which may be expressed as a period of time, may be called the life or lifetime of the object. The first appearance and last appearance are characteristics showing time evolution of the object over the set of frames, as is velocity. Other characteristics showing time evolution are, for example, location, size, orientation, detection score, track confidence, tracking life, and distribution of colors; these other characteristics should be recorded for at least two frames to show time evolution.

In each step of FIG. 2, the amount of data is substantially reduced; for example, a video frame, usually several megabytes in size, in a video stream may be described by a combination of classifier detections of the order of tens of kilobytes, which may in turn be described by an object record comprising data corresponding to several frames (two or more) in a single data block of the order of a few kilobytes. The object record may thus be transmitted to the second processing system for further analysis as depicted in FIG. 1, requiring significantly less transmission bandwidth than would be required to transmit the entire video stream or the complete frames appertaining to the object record.

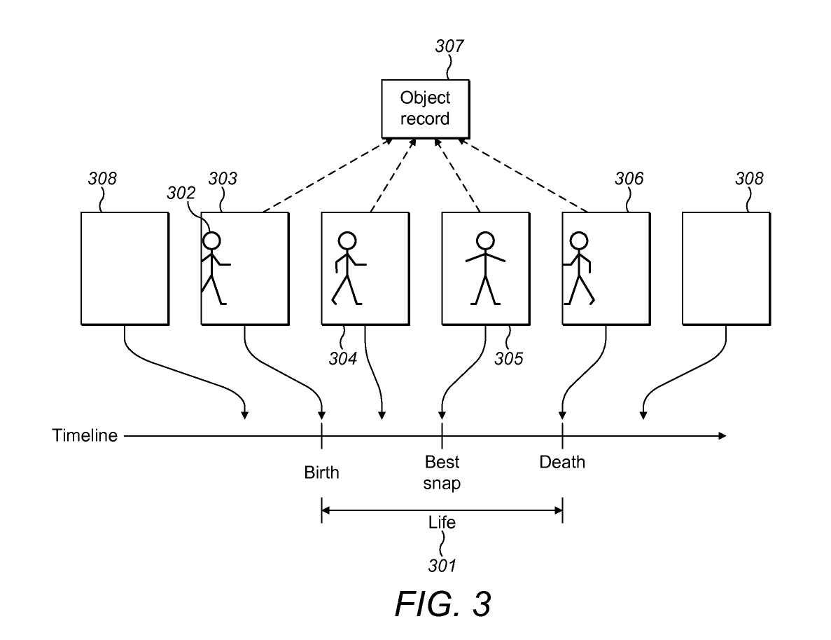

FIG. 3 indicates some key time points over the life 301 of an object 302, in this case a person in a video stream. The birth of the object is the event that the object appears for the first time in the video stream. It occurs at the time corresponding to the first frame in which the object is detected 303, in this case corresponding to the person entering from the left. Data are then generated as the person moves around 304. A “best snap” 305 may optionally be identified as the frame in which the detection score of an object is maximal or at which the detection score exceeds a predetermined threshold. For example, the detection indicates a specific orientation of the object with respect to the camera. When detecting a person, a best snap can be a frame in which a given part of the person, for example the face, is directed towards the camera. The death of the object is the event that the object disappears from the video stream; it occurs at the last frame in which the object is detected 306. The life of the object is the timespan over which the object is present in the video stream or, in other words, the time between the birth and death of the object. Data corresponding to at least some frames in which the object is present are included in the object record 307, but data corresponding to frames in which the object is not present 308 are typically not included.

Depending on the requirements of the specific embodiment, the amount of data recorded and then included in the object record and transmitted to the server may vary. In a minimal example, it may be desirable to record only characteristics of the object corresponding to its configuration at birth and its configuration at death, thus minimizing the total amount of data to be transmitted and stored. Alternatively, in addition to characteristics at birth and death, it may also be desirable to record characteristics of the object corresponding to its configuration at a number of intermediate times between birth and death, for example corresponding to the “best snap” described above or corresponding to the point at which the object crosses a boundary in the video frame, or corresponding to regularly spaced time points over the object lifetime, allowing an relatively easy analysis of the track or motion of the object in the imaged scene.

As another example, if full information is desired regarding the history or time-evolution of the object, it may be desirable to record in the object record data describing characteristics of the object for each frame over its entire life, thus providing fuller information but requiring higher transmission bandwidth. Alternatively, data may be recorded in the object record at irregular intervals corresponding to the motion of the object, for example when the object has moved a predefined distance from its previous location. Since a timestamp may be recorded at each such interval, the full motion of the object can be later reconstructed.

It may further be desirable to post-process the object record to reduce the amount of data, before analyzing the object record. For example, the number of time points may be downsampled, or an arithmetic function, such as a spline curve, may be fitted to the object trajectory.

The object record is transmitted to the server in at least one chunk or part; the timing of the transmission may be determined by content of the video stream. The timing may vary according to the specific implementation of the invention, independently of the timing of generation of the object record described above. For example, the total number of transmissions may be minimized by transmitting the entire object record at or after the death of the object. However, this may not always be desirable. For example, a first part of the object record may be transmitted at or after the first frame in which object is detected, and a second part, which may comprise the remainder of the object record, may be transmitted at or after the last frame in which the object is detected. As another example, in a system configured to detect intruders in security camera footage, it may be desirable to transmit a first part of the object record indicating a detection at the time of birth of the object, corresponding to the entry of an intruder, followed by a second part at the time of “best snap” to enable accurate identification of the intruder at the earliest possible time, followed in turn by a third part at the death of the object, corresponding to the exit of the intruder.

In this manner, the method may include performing the analyzing of the object record at at least one time at which the object is detected in the video stream. Continuing the example of an intruder in security camera footage, a part of the object record may also be transmitted, for example, at a time corresponding to a change in a characteristic of the object such as when the intruder crosses a boundary in the video frame, for example when entering a different room. The second processing system typically combines the received object record parts such that, regardless of the total number of transmissions, a single object record is produced containing all transmitted data corresponding to the object. According to other embodiments, the object record, or multiple object records corresponding to different objects, may be transmitted after a predetermined time, at a predetermined time of day, or after generating a predetermined number of object records.

In addition to the data described above, additional data such as an image or images corresponding to part of a frame or frames, for example a thumbnail or multiple thumbnails, may be included in the object record. As an illustrative example, a thumbnail comprising a cropped portion of a video frame including a detected human face may be captured at the time of “best snap”, and selected for inclusion in an object record. The additional data could alternatively comprise, for example, a histogram of the color distribution in a relevant portion of the image. One or more entire frames of the video could also be included in the object record.

As shown in FIG. 1, the transmitted object record, including any additional data such as histograms, are analyzed by the second processing system. For example, a thumbnail corresponding to a human face captured at the time of “best snap” may be included in the object record in the first analysis, and then analyzed in the second analysis using a facial recognition algorithm, examples of which are well known in the art, to identify a person in a video stream. According to some embodiments where the second processing system is a server, results of this analysis may be transmitted back to the camera.

As an illustrative example, the camera may track a person in the video stream, initially identifying that person with an identification number. A thumbnail corresponding to the person's face may then be captured when the detection score for a “front-oriented face” classifier exceeds a pre-determined threshold. The thumbnail may then be transmitted to the server, where the identity of the person is determined using a facial recognition algorithm. This identity can then be transmitted back to the camera, so that the detected person may be identified by their name across the entire history of the object, possibly including in frames of the video corresponding to times before the person was identified.

Similarly, if the object record is stored in a server, an identifier contained in the stored object record can be replaced by the person's name. Facial identification algorithms typically require fast access to large databases of facial information and are thus ideally implemented at a server; the present method allows application of such a method without requiring the significantly higher bandwidth costs incurred in transmitting the entire video for analysis to the server. Also, facial identification algorithms are expensive to run on all objects in every frame of a video sequence. By supplying only one or a few image crops on frames where the face has been captured with size and orientation suitable for facial recognition, it is possible to avoid large amounts of wasted computation.

A preferred orientation is the one that is most suitable of facial recognition. For example, a person may be recognized and tracked efficiently over their life within a video sequence via just one or a small number of well-chosen facial recognition attempts. The size of data transmitted may be further reduced by, for example, compression of the object record using a known compression algorithm. The size of data transmitted may also be reduced by not including in the object record data corresponding to every frame in the set of frames in which the object is present, but instead including in the object record data corresponding to a subset of frames of the video stream, the subset being a subset of the set of frames in which the object is present. For example, data relating to one frame in every 10 frames of the set may be included in the object record, or relating to one frame per minute. Such a subset of frames may also be selected based on the motion of the object, for example by selecting a frame once the object has moved a predetermined distance in the frame.

Different stages of this method may be carried out at different times. For example, in the embodiment described above in which security camera footage is monitored for intruders, it may be desirable to perform both object detection at the camera and facial identification at a server in real time, such that the analyzing is performed while the object is present in the video stream. As another example, it may be desirable the perform object detection and object record generation in real time, but to analyze the object record at or after a time at which the object is no longer present in the video stream. Alternatively, it may be desirable to produce an object record in real time and to store this as metadata in a video file containing at least part of the video stream, from where it may be, at a later date, transmitted to the server for further analysis.

A further embodiment is envisioned in which at least part of a video is initially stored as a video file in a memory unit at the camera, and both object detection and object record analysis occur at a later point in time. In any case, the result of the analysis at the server may be stored as additional metadata in, or as an attachment to, a video file containing the video stream. The server may also store the results of the analysis in a database.

Either the additional metadata in the video file at the camera, or the database at the server, may be queried to extract information regarding the analysis. This would allow multiple video files to be indexed according to characteristics of the detected objects. For example, it may be desirable to store the total number of different people in the video stream, or the times at which a given person was present. This may be implemented at the server without requiring the full video files to be transmitted to the server. The presence of one or more specified objects may then by searched for within a set of video files, by searching for the corresponding one or more object records.

Scenarios are envisaged in which multiple object records corresponding to the same object may be produced. For example, multiple cameras may record the same scene or different scenes and independently produce object records corresponding to a single object. In addition, an object may exit the scene and later re-enter the same scene, be temporarily occluded from view, or be mistakenly undetected for a period of time; all of these scenarios may lead to the same object being detected as multiple distinct objects, with multiple associated object records. For example, an object may enter the video, be detected, and exit. If the same object re-enters, it may be detected as a further object, not related to the first, and a new object record may be generated.

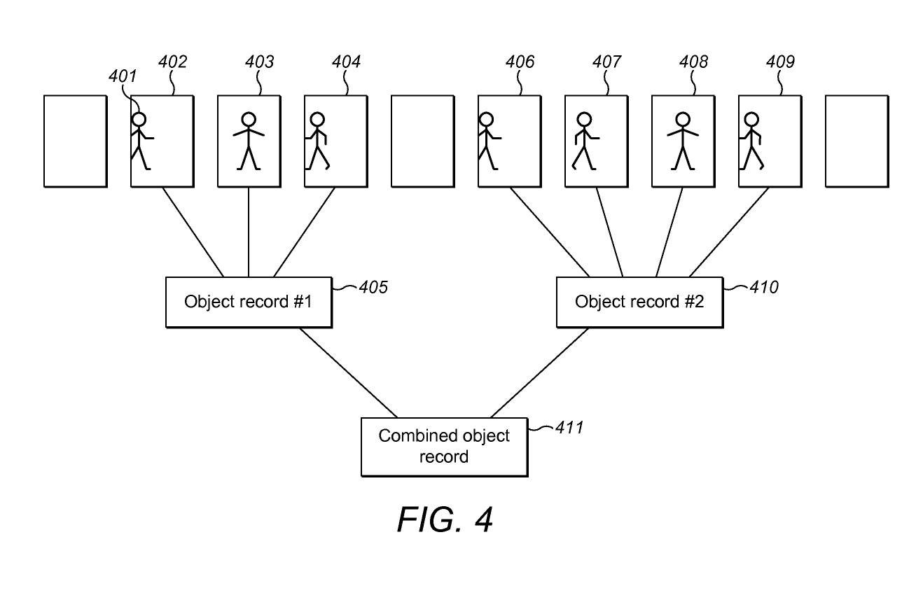

According to some embodiments, the present invention may combine such multiple object records to produce a single object record corresponding to the object. By way of example, FIG. 4 depicts a person 401 entering a frame 402. The person is also present in further frames 403 and 404, and then leaves the video stream. Data corresponding to the frames 402, 403, 404 in which the person was present are included in a first object record 405.

The person then re-enters the video stream in a frame 406, is also present in further frames 407, 408, 409, and then leaves the video stream. Data corresponding to these frames are included in a second object record 410. It is then determined that the two object records correspond to the same person, for example by using a facial recognition algorithm, and the first and second object records are combined into a combined object record 411.

Various methods may be used to determine that separate object records correspond to the same object. For example, the server may determine, using a facial recognition algorithm, that two human figures detected at different times are in fact the same person and merge the object records of the two figures to form a single object record. As another example, the camera or server may analyze the color distribution of pixels corresponding to two objects and, if they match to within a pre-determined margin of error, decide that the two objects are in fact one object and merge the object records of the two objects.

This may be performed as follows. For each frame in which the object is detected, an average value and standard deviation of each color component (for example red, green, and blue) is measured within a region defined by the object detection algorithm as corresponding to the object. This color information is included in the corresponding object record. Subsequently the correlation between the color information of two or more object records may be measured, and an association made between the object records if the correlation is sufficiently high.

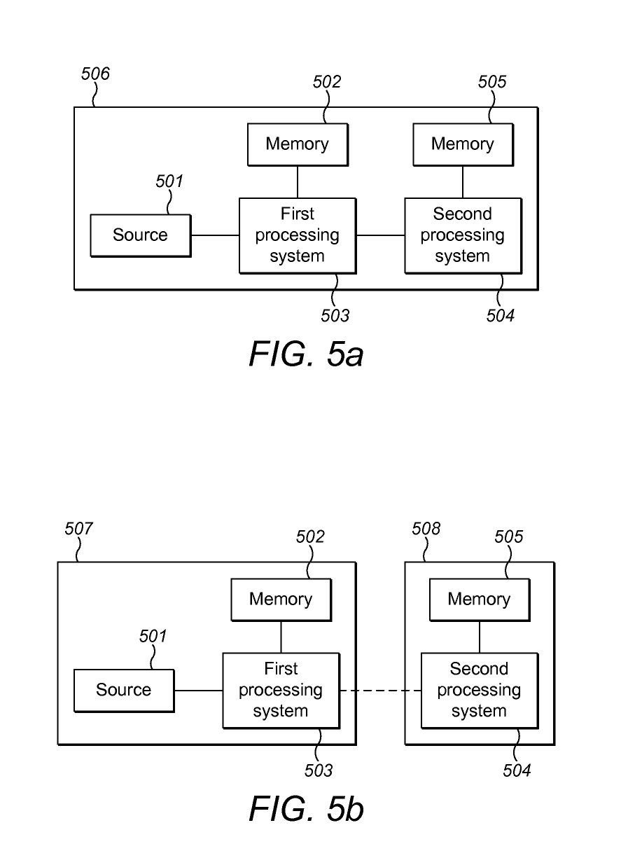

Two exemplary embodiments of an apparatus for carrying out the above described methods are shown in FIG. 5. FIG. 5a presents a source 501 providing a video stream, which may for example be a camera providing live footage, and a memory 502 containing computer programming instructions, configured to cause the processor to detect an object in the video stream and generate an object record in the manner described above, each connected to a first processing system 503. The first processing system is also connected to a second processing system 504 which is connected to a second memory 505 containing computer program instructions, configured to analyze the object record according to the description above. According to some embodiments, the memories 502 and 505 may be a single memory unit. All components are contained within a single device 506, which may for example be a camera or a smartphone.

FIG. 5b presents a source 501 and a memory containing computer programming instructions 502 as described above with reference to FIG. 5a connected to a first processing system 503, these being contained within a first device at a first location 507. The first device is connected to a second processing system 504 which is in turn connected to a second memory 505 containing computer program instructions as described above with reference to FIG. 5a; both of which being within a second device at a separate location 508. The first device may be a camera or smartphone, and the second device may be a server.

The above description may be generalized to a distributed network of cameras. In this case, the second device is another camera on the network. This enables the record of an object captured by one camera to be transmitted to another camera or cameras, allowing the presence and behavior of an object to be compared between the different devices.

The above embodiments are to be understood as illustrative examples of the invention. Further embodiments of the invention are envisaged. For example, the source may be a memory within a computer, and the first and second processing systems may both be implemented within a processor in the computer. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for analyzing a video stream having frames, the method comprising:
determining a set of the frames in which an object is present using an object detection algorithm; and
generating at least one object record from content of the video stream, the object record including time evolution of at least one characteristic of the object in the set of the frames.

2. The method according to claim 1, further comprising analyzing the object record and obtaining a result of the analysis.

3. The method according to claim 2, wherein:
the determining a set of frames and the generating an object record are performed at a first location;
the analyzing the object record is performed at a second, different location; and
the method further comprises transmitting the object record from the first location to the second location at a time of transmission.

4. The method according to claim 3, wherein the time of transmission is determined by the content of the video stream.

5. The method according to claim 3, wherein the time of transmission is a predetermined time of day.

6. The method according to claim 3, wherein the time of transmission is after generating a predetermined number of object records.

7. The method according to claim 3, wherein the time is after a last frame in which the object is present.

8. The method according to claim 3, further comprising:
determining a strength of response for the object using the object detection algorithm; and
setting the time after the strength of response exceeds a predetermined threshold.

9. The method according to claim 3, wherein the object record comprises a plurality of parts; and the transmitting comprises separate transmissions of the plurality of parts from the first location to the second location.

10. The method according to claim 9, wherein the plurality of parts comprises at least a first part and a second part; and the transmitting comprises:
transmitting the first part at or after first identifying the object in the video stream and at the latest at the last identifying of the object in the video stream; and
transmitting the second part after the last identifying of the object in the video stream.

11. The method according to claim 9, wherein the timing of each of the separate transmissions depends on a change of at least one characteristic of the object.

12. The method according to claim 1, further comprising performing the identifying the object in the video stream in real time.

13. The method according to claim 2, further comprising storing the result of the analyzing in the object record.

14. The method according to claim 1, further comprising:
saving at least part of the video stream as a video file; and
saving the at least one object record as part of, or as an attachment to, the video file.

15. The method according to claim 2, further comprising identifying the result of the analyzing, in the object record, as applying to the object in at least one frame corresponding to a time before the obtaining the result.

16. The method according to claim 1, wherein the at least one characteristic is chosen from the list consisting of a position of the object, a size of the object, an angle of orientation of the object, a strength of response of the object detection algorithm, a unique identifier corresponding to the object, object type, tracking life, object velocity, color distribution within the object, object first appearance indicator, object disappearance indicator, and a time stamp.

17. The method according to claim 2, wherein performing the analyzing the at least one object record happens at or after the time when the object is no longer present in the video stream.

18. The method according to claim 2, wherein performing the analyzing the at least one object record happens at at least one time when the object is detected in the video stream.

19. The method according to claim 1, wherein the object is at least part of a human.

20. The method according to claim 19, wherein the at least part of a human is a human face.

21. The method according to claim 1, wherein:
the object record includes an image representing a frame or frames, or part of a frame or frames, of the video stream.

22. The method according to claim 21, further comprising selecting the image in response to a strength of response of the object detection algorithm exceeding a predetermined threshold.

23. The method according to claim 21, wherein the image is a part of a frame corresponding to a human.

24. The method according to claim 23, further comprising determining the identity of the human.

25. The method according to claim 24, further comprising storing the identity of the human in the object record.

26. The method according to claim 3, further comprising transmitting the object record from the first location to the second location, and reducing at the first location the size of data to be transmitted to the second location.

27. The method according to claim 26, wherein the reducing the size of data at the first location includes selecting data corresponding to a subset of frames of the video stream.

28. The method according to claim 27, further comprising selecting the subset based on motion of the object.

29. The method according to claim 1, further comprising:
identifying a further object in the video stream or in a further video stream;
determining that the object and the further object are the same object; and
combining or associating the object records corresponding to the object and the further object.

30. The method according to claim 29, wherein:
the object and the further object are people; and
the determining comprises using a facial recognition algorithm to determine that the object and the further object correspond to the same person.

31. The method according to claim 29, wherein the determining comprises analyzing color distributions of the first and second objects.

32. The method according to claim 3, further comprising storing the at least one object record in a database at the first location or at the second location.

33. A method for searching for the presence of one or more specified objects within a set of video files, at least one video file including at least one object record as in claim 1, the method further comprises analyzing the at least one object record and determining whether the at least one object record pertains to the specified object.

34. A first apparatus for processing a video stream having frames at a first location, the apparatus comprising:
at least one processor; and
at least one memory including computer program instructions,
wherein the at least one memory and the computer program instructions being configured to, with the at least one processor, cause the apparatus to perform a method of:
determining a set of the frames in which an object is present using an object detection algorithm;
generating at least one object record from content of the video stream, the object record including time evolution of at least one characteristic of the object in the set of the frames.

35. A second apparatus for processing an object record, including time evolution of at least one characteristic of an object, at a second location, the apparatus comprising:
at least one processor; and
at least one memory including computer program instructions,
wherein the at least one memory and the computer program instructions being configured to, with the at least one processor, cause the apparatus to perform a method of:
receiving the object record from a first location;
analyzing the object record; and
obtaining a result of the analyzing.

36. A system for processing a video stream, comprising
a first apparatus for processing a video stream having frames at a first location, the first apparatus comprising:
at least one processor; and
at least one memory including computer program instructions,
wherein the at least one memory and the computer program instructions being configured to, with the at least one processor, cause the apparatus to perform a method of:
determining a set of the frames in which an object is present using an object detection algorithm;
generating at least one object record from content of the video stream, the object record including time evolution of at least one characteristic of the object in the set of the frames; and
a second apparatus for processing an object record, including time evolution of at least one characteristic of an object, at a second location, the second apparatus comprising:
at least one processor; and
at least one memory including computer program instructions,
wherein the at least one memory and the computer program instructions being configured to, with the at least one processor, cause the apparatus to perform the method of:
receiving the object record from a first location;
analyzing the object record; and
obtaining a result of the analyzing.
